(19) United States
(12) Patent Application Publication
(10) Pub. No.: US 2026/0113785 A1
(43) Pub. Date: Apr. 23, 2026

(54) CONTENTION REDUCTION FOR WIRELESS NETWORKS

(71) Applicant: Vodafone Group Services Limited, Newbury, Berkshire (GB)

(72) Inventors: Chandrika WORRALL, London (GB); Chris PUDNEY, London (GB)

(21) Appl. No.: 19/160,267

(22) PCT Filed: Mar. 7, 2024
(86) PCT No.: PCT/GB2024/050606

§ 371 Date: Aug. 27, 2025

(30) Foreign Application Priority Data
Mar. 13, 2023 (GB) 2303664.3

(51) Int. Cl. H04W 74/0833; H04W 56/00; H04W 72/1268; H04W 84/06

(52) U.S. Cl. CPC H04W 74/0833; H04W 56/0045; H04W 72/1268; H04W 84/06

(57) ABSTRACT

A method and system for providing a communications channel between a user equipment (UE) and a base station, the method includes base station determining a level of communications traffic. the base station transmitting a random access response (RAR) message including a plurality of different physical random access channel (PRACH) preamble signatures, wherein if the determined level of communications traffic is below a threshold then the RAR message includes the same uplink grant allocation for each of the plurality of different PRACH preamble signatures, and if the determined level of communications traffic is above the threshold then the RAR message includes different uplink grant allocations for each of the plurality of different PRACH preamble signatures.

### FIELD OF THE INVENTION

The present invention relates to a system and method for reducing contention in wireless networks and especially within satellite wireless networks.

### BACKGROUND OF THE INVENTION

A satellite communication system can communicate with unmodified user equipment (e.g., LTE) devices. However, this requires the use of a legacy initial access/random access procedure to provide user equipment (UE) with access to the network. However, due to the long propagation delay experienced in satellite networks, base station operation with regards to the random-access procedure can be unreliable or impossible. For example, message responses may be required (or time-out) outside possible signal transit times. This may be less of a problem when a satellite is overhead but becomes unworkable as the satellite moves beyond a position in the sky when signal transit times increase beyond a threshold. Furthermore, the inevitable increase in signal transit times for random-access messages can lead to increases in random access preamble collisions between UEs and so increases the need for contention resolution leading to further inefficiencies. The term collision means random access preamble collision.

Therefore, there is required a method and system that overcomes these problems.

### SUMMARY OF THE INVENTION

In order for an efficient communications channel to be set up between a base station (eNodeB) and user equipment (UE) then certain signal timing and frequency parameters need to be set. This is achieved using a random access (RA) procedure that includes a number of messages being sent between the base station and the UE. This may be described as a synchronisation stage, as timing information may be provided to take into account propagation and other delays in the communication channel. Preferably, the method is used within an LTE, 4G, or 5G (or beyond) environment.

The base station may broadcast the number of physical random access channel (PRACH) preambles (preambles) from which a UE may randomly select. Each preamble has a particular identifier or signature. Typically, there may be 64 different preambles, each having a different signature. Having fewer different preambles increases the risk of random collisions between different UEs but this risk can be low at correspondingly low communication traffic volumes. The term collision means random access preamble collision throughout this description.

In an example implementation, the number of available preambles is reduced to four (e.g., denoted by: a, b, c, and d). The messages may be sequential and numbered (1, 2, 3, and 4). During message 1, a UE includes one of the randomly selected preamble signatures (selected by the UE). Message 1 is transmitted by the UE and received by the base station (eNodeB).

The base station responds to message 1 with a random access response message (message 2). Ideally, message 2 contains the same preamble signature as message 1 together with an uplink (UL) grant allocation (e.g., time and/or frequency allocation) that is determined by the base station as being appropriate to the UE. For example, if there is a very small delay between when message 1 is transmitted and received by the base station (e.g., based on timing information within the message and the actual time of reception) then the base station may also include a small timing advance in message 2. However, if there is a larger delay then a greater timing advance will be provided. Therefore, the message timing should at least partially compensate for the physical distance between the base station and the UE.

Provided message 2 is received within a predetermined or set time from the transmission of message 1 then the UE sends a further message (message 3) that includes the same preamble and a temporary identifier of the UE (e.g., a 40 bit identifier).

The base station responds with message 4 that again includes the temporary identifier of the UE and any timing advance correction that may be required. If the UE successfully receives message 4 (and it contains the correct temporary identifier of the UE) then the random access process can complete. Otherwise, the UE restarts the process with a further message 1, e.g., with a different randomly selected preamble signature (which may be the same or different from the first preamble).

However, when a satellite is being used as an intermediary between the UE and the base station then delays are added to the signalling and the random access process described above is likely to fail multiple times. A single message 2 can include more than one preamble (e.g., contained within separate message headers). These message 2s include all possible preamble signatures. To reduce the size of the message 2s the number of possible preambles is reduced (e.g., to four). The base station can send message 2s in response to received message 1s or the base station can instead send the random access response messages at regular intervals (or at other times) and without first receiving any message 1s (from UEs).

The UE may send a message 1 (including one of the possible preamble signatures according to a configuration of the base station) and either receive one of the unprompted (regular) message 2s or time-out and retransmit a new message 1. In any case, because the message 2 received by the UE contains the same preamble signature (as either its first or subsequent message 1) and it was received within a time-out period of its last message 1 (either the first or subsequent message 1) then it can move on to sending a confirmation (message 3) and do so immediately. However, there is a possibility that another UE may also receive the same message 2 transmitted (e.g., unprompted) by the base station. If this occurs, then it may use the same uplink grant allocation (e.g., frequency) that is contained within the message 2 and a collision is likely between the first UE and the second UE.

When there are fewer UEs present and attempting to connect (over satellite or in another high-latency enviroment) to the base station then it is more efficient to allocate the same uplink grant allocation to each preamble in each message 2 transmitted by the base station because this minimises the use of unused physical uplink shared channel (PUSCH) resources. When communications traffic increases due to an increased number of UEs attempting to connect, then allocating different uplink grant allocations to each preamble signature in the (e.g., unprompted) message 2s becomes more advantageous as this reduces the risk of collision. Therefore, the base station or other parts of the network monitor communications traffic. Below a particular or predetermined threshold, the message 2s (prompted or unprompted) contain the same uplink grant allocations for each preamble signature and above the threshold, each preamble signature is allocated different uplink grant allocations or PUSCH resources.

In accordance with a first aspect there is provided a method for providing a communications channel between a user equipment (UE) and a base station, the method comprising the steps of:
the base station determining a level of communications traffic; and
the base station transmitting a random access response (RAR) message including a plurality of different physical random access channel (PRACH) preamble signatures, wherein
if the determined level of communications traffic is below a threshold then the RAR message includes the same uplink grant allocation for each of the plurality of different PRACH preamble signatures; and
if the determined level of communications traffic is above the threshold then the RAR message includes different uplink grant allocations for each of the plurality of different PRACH preamble signatures. Therefore, the random access process success rate is improved for higher latency and propagation delay communication systems such as those using satellite uplink. The PRACH preamble signatures are tokens, identifiers, strings, numbers, characters, or other data items used to initiate a PRACH. The uplink grant allocation may include time/frequency resources. For example, the frequency resources may be a subset of allocated frequencies (e.g., 6×180 kHz). Timing advance information may also be included. This may be determined based on a distance or time delay for particular UEs. Timing advance information may be determined before or after the RAR message is transmitted.

Optionally, the plurality of different PRACH preamble signatures are all possible PRACH preamble signatures for the base station. A base station or gNodeB has a set of possible PRACH preamble signatures. The base station can broadcast the range or available PRACH preamble signatures. Typically, the range of available PRACH preamble signatures may be four to 64. Therefore, the base station can have a particular current configuration with any number of possible PRACH preamble signatures that it can accept. Optionally, there may be four different PRACH preamble signatures. Limiting the number of available PRACH preamble signatures to the minimum of four minimises the size of the RAR message, whilst avoiding UEs from failing to receive a response within an expected time limit. However, advantages will still be apparent for other numbers of preambles.

Optionally, the base station may transmit the RAR message in response to receiving a message from the UE containing a single PRACH preamble signature of the plurality of PRACH preamble signatures. The RAR message may be sent so that it is received within a required time frame or RAR window or even after the UE has sent a further initial message.

Optionally, the base station may transmit the RAR message in the absence of receiving a message from a UE containing a single PRACH preamble signature of the plurality of PRACH preamble signatures. The base station can send RAR messages at regular intervals even when it does not receive an initial message (containing a single PRACH preamble signature) first. Therefore, UEs are more likely to receive a RAR response message within a timeframe spanning a RAR window of sending their first message (containing a single PRACH preamble signature).

Optionally, the method may further comprise the steps of:
the base station allocating packet uplink shared channel, PUSCH, resources to the UE that transmitted the message containing the single PRACH preamble signature; and
the base station transmitting a further message to the UE containing an identifier of the UE, wherein the further message confirms the PUSCH resources allocated to the UE. The base station can use the first message (and/or subsequent first messages) received from the UE to allocate the PUSCH resources.

Optionally, the message received by the base station may be a second message transmitted by the UE containing a PRACH preamble signature, wherein a first message transmitted by the UE contains a different PRACH preamble signature of the plurality of PRACH preamble signatures to the second message transmitted by the UE. Therefore, the UE can avoid having to send further first messages (containing a PRACH preamble signature) as the UE will receive a RAR response containing a PRACH preamble signature that it expects (including all others).

Optionally, the base station may determine the level of communications traffic based on:
a number of messages received by the base station containing a single PRACH preamble signature within a time period, and/or
a number of non-decodable messages received from one or more UE containing a single PRACH preamble signature. There may be other ways that the base station or eNodeB can determine the traffic level.

Optionally, the base station may determine a level of communications traffic based on historical records of communications traffic. These may be stored at the base station or retrieved from an external source or server.

Advantageously, the historical records of communications traffic may be analysed using artificial intelligence, Al or machine learning techniques. Other analytical methods may be used.

Preferably, the RAR message further includes the same timing advance information for each of the plurality of different PRACH preamble signatures. Timing advance information can be included in the RAR message. Using the same timing advance information may reduce PRACH resource use. However, different timing advances may be used for each PRACH preamble signature. This avoids collision, especially in high communications traffic (above a particular threshold) environments.

Optionally, the RAR message including the plurality of different PRACH preamble signatures is repeated at regular time intervals. This further avoids collision, especially in high communications traffic (above a particular threshold) environment.

Preferably, the RAR message may be repeated once every RAR window. The RAR message may also be repeated at different intervals (e.g., every other, 3, 4, or RAR window).

Optionally, the method may further comprise the steps of:
the base station receiving a message from the UE containing a single PRACH preamble signature of the plurality of PRACH preamble signatures;
determining that the message received from the UE does not comply with timing advance information allocated to the PRACH preamble signature within the message; and
transmitting a further RAR message containing a further uplink grant allocation, wherein the further uplink grant allocation has a timing advance based on a position of a RAR window when the messages was received from the UE. This can be useful if the RAR response message is not in direct response to an initial message from the UE (i.e., containing the PRACH preamble signature) or not in response to any initial or first message from the UE. The timing advance information included with the RAR response, for example, may be tuned or optimised to account for timing delays or latency later on and allow the random access process to complete. Determining that the message received from the UE does not comply with timing advance information (or that this timing advance is inappropriate) allocated to the PRACH preamble signature within the message may be achieved by analysing the message 3 (and its timing), as received from the UE by the base station.

Optionally, if the base station receives two or more messages from different UEs, wherein the two or more messages contain the same PRACH preamble signature then:
the base station may allocate one set of packet uplink shared channel, PUSCH, resources;
the different UEs using these PUSCH resources to send a message containing their identifiers; and
the base station may select one of the UE identifiers and responding with a message containing the selected UE identifier. This may be based on the UE that sends out the message with the highest power or highest signal, for example.

According to a second aspect, there is provided a satellite telecommunication system comprising:
one or more base stations having means adapted to execute the steps according to any previous claim.

The methods described above may be implemented as a computer program comprising program instructions to operate a computer. The computer program may be stored on a computer-readable medium, including a non-transitory computer-readable medium.

According to a third aspect, there is provided a data processing apparatus or system comprising means for carrying out any method described above.

According to a fourth aspect, there is provided a computer-readable storage medium (tangible or non-tangible) comprising instructions which, when executed by a computer, cause the computer to carry out any method described above.

The computer system may include a processor or processors (e.g., local, virtual or cloud-based) such as a Central Processing Unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a satellite telecommunications network, including a base station and user equipment (UE);

FIG. 2 shows a schematic diagram of messages used to set up communications between the base station and the UE of FIG. 1;

FIG. 3 shows a schematic diagram of a random access procedure used within the satellite telecommunications network of FIG. 1, including timing information;

FIG. 4 shows a flowchart of a method for providing a communications channel between the UE and the base station of FIG. 1;

FIG. 5 shows a schematic diagram of messages used within the method of FIG. 4;

FIG. 6 shows a graph showing the transmission power of messages within the satellite telecommunications network of FIG. 1; and

FIG. 7 shows a flowchart of a method for calculating timing advance within the method of FIG. 4.

It should be noted that the figures are illustrated for simplicity and are not necessarily drawn to scale. Like features are provided with the same reference numerals.

### DETAILED DESCRIPTION OF THE PREFERRED EMBODIMENTS

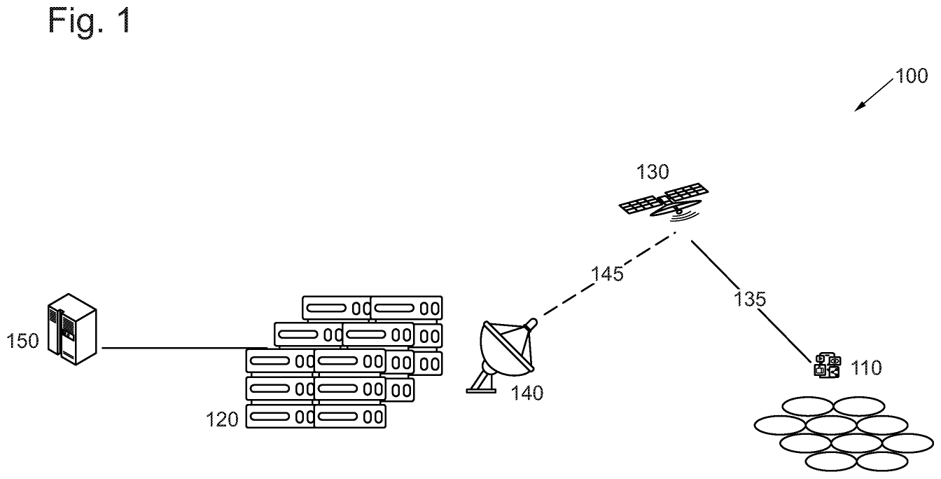

FIG. 1 shows a schematic diagram of a satellite telecommunications system 100 including one or more UEs 110. In this figure, a satellite 130 is within view of the UE 110. A ground-based gateway 140 has a feeder link 145 to the satellite 130, which provides a service link (Uu) 135 to the UE 110. In this example implementation, there are a plurality of base stations 120 in communication with the gateway 140 (e.g., wired, wireless, microwave, etc.) but the base station(s) 120 may alternatively be located within the satellite 130. The base stations (eNodeBs) 120 may be modified, as described, and are located at ground level and connected to the satellite payload via the gateway or gateway station 140. The base stations 120 are also in communication with other network components such as a mobility management entity (MME) or serving gateway (SG) 150.

FIG. 1 illustrates an example of a satellite system providing access to a 3GPP unmodified UE 110. The UE 110 (e.g., an LTE UE) may be served by a E-UTRAN system. The satellite payload transparently forwards the radio protocol received from the gateway 140 (via the feeder link 145) to the UE 110 (via the service link 135) and vice-versa.

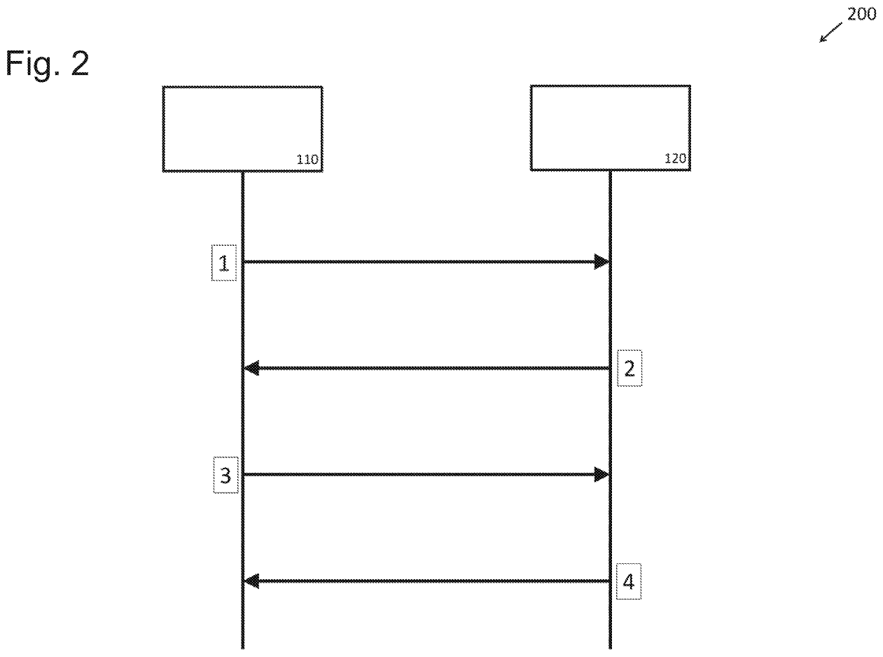

FIG. 2 shows a schematic diagram of a method 200 for transmitting and receiving messages used to set up communications between the UE 110 and the base station 120. The message numbers correspond to the numbers next to each arrow in FIG. 2. This process is a random access scheme for setting up packet uplink shared channel (PUSCH) resources for the UE 110. The UE 110 selects (randomly) a physical random access channel (PRACH) preamble signature from those available. For example, the base station 120 may broadcast information allowing any UE 110 to determine the set of available PRACH preamble signatures.

In this example, the number of available PRACH preamble signatures is limited to four but any number may be used. Typically, 64 PRACH preamble signatures are available but limiting to four (or any number fewer than 64) is advantageous. This number may be broadcast by the base station (eNodeB) 120 so that UEs can randomly select one preamble from those available.

The UE 110 randomly selects one PRACH preamble signature (a preamble) with (e.g., with signature p1) and transmits preamble p1 at time T1 (p1 is any one of the four possible preambles a, b, c, and d). This preamble p1 is included in message 1, as shown in FIG. 2. Usually, the base station 120 will respond to a message 1 with a random access response (RAR) message (message 2 in the figure) that provides the UE 110 with an uplink (UL) grant allocation and timing advance (TA) information, i.e., PUSCH resources. This process allows the UE 110 to determine which message 2 should be processed (as it contains a matching preamble) and enables the UE 110 to respond to the correct message 2. The UE 110 will then respond to message 2 (that contains the same preamble that it transmitted) with a message 3 (a scheduled transmission sent according to the allocated uplink resources and any timing advance), including a RRCConnectionRequest, which contains the UE's 40 bit temporary ID, or a randomly allocated 40 bit number that the UE 110 provided. If the base station 120 receives message 3 and its contents are determined to be correct, then it responds by transmitting a message 4 to the UE 110 that may include contention resolution information but otherwise confirms that the random access process has completed correctly and the communication channel with the UE 110 is set up.

However, in the absence of random access response (RAR) message, the UE 110 again randomly selects a preamble from those available to include in a further message 1. In this example, p2 is selected (p2 is any one of the four preambles a, b, c, or d) and transmits it at T2 (a second attempt). In the satellite telecommunications system 100, it is likely that the UE 110 will not receive a RAR message (message 3) in response to the first message 1 within an allocated time or time-out period due to the latency of the communications and signal transit time (up and down via the satellite).

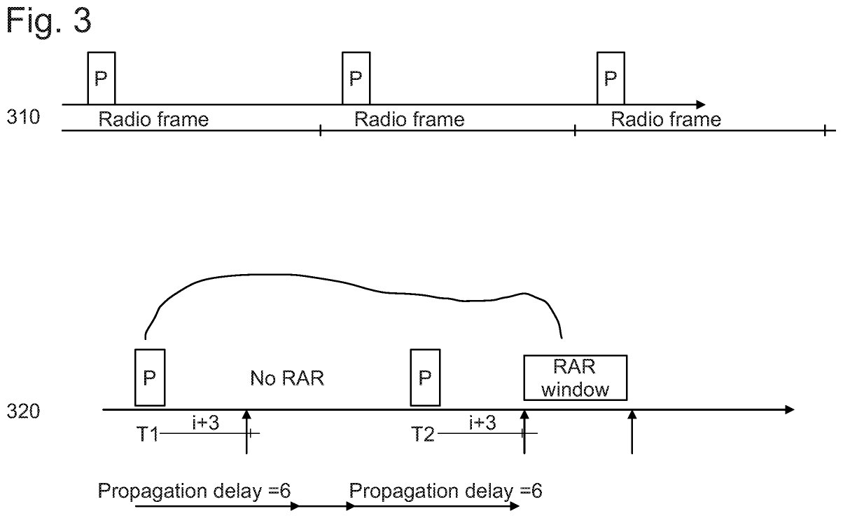

FIG. 3 shows schematically the timing of this process. The top row 310 illustrates a series of radio frames where possible message 1s (P), containing a preamble may be sent. The bottom row of FIG. 3 (320) illustrates how propagation delay leads to the message 2 (RAR) being received at the UE 110 (within the RAR window) after a second message 1 is sent by the UE 110 at time T2. This second message 1 is actually in response to the first message 1 (illustrated by the curved line in this figure). In this example, the propagation delay may be 6 ms, as shown in row 320.

Usually, it can be expected that a message 2 will only contain a preamble corresponding to the message 1 received by the base station 120 and that prompted the base station 120 to send it (in this example preamble p1). In this example, the base station would usually transmit a RAR message (message 2) corresponding to the preamble transmitted at T1. Otherwise, the UE 110 will ignore any message 2 that does not contain the last preamble signature that it sent (which may change each time). Where there is an expected delay beyond the time-out period then every message 2 is likely to be ignored according to this scheme.

The base station 120 will receive a message 1 from the UE 110. In response to the message containing preamble p1 sent at T1, (and knowing when the specification requires that the UE 110 retransmits a further message 1 containing another preamble) the base station 120 transmits a RAR message (message 2). The UE 110 may now be searching for a response associate with the preamble p2 and not a response to its first message 1containing preamble p1. However, this problem is solved by all message 2s (RAR messages) transmitted by the base station 120 modified to contain multiple headers including a preamble signature for every possible preamble (according to a modified configuration of the base station). Each preamble will also be provided with or associated with uplink grant allocations. These can either have the same uplink grant allocations (and any suitable timing advance information) as each other or each have different uplink grant allocations (and any necessary timing advance information).

Therefore, according to this improved scheme, the base station 120 ensures that its RAR message (message 2) responds to the message 1 containing preamble p1 transmitted at T1 using all the possible preambles (because it is unlikely that the UE 110 is still looking for a response containing preamble p1 when it actually receives the RAR message). Therefore, the base station 120 can pre-emptively respond to the second message 1 (containing preamble p2) from the UE 110 (even though it has not yet received it) by transmitting a message 2 that will satisfy all possible combinations of preamble signatures, including the message 1 sent by the UE 110 at T2. The UE 110 receives the message 2 including all possible preamble signatures (a, b, c, and d). The UE 110 can treat this message 2 as a response to its second message 1 that contains preamble p2 (which is really a response triggered by the message 1 containing preamble p1 transmitted at T1). Therefore, success of the random access process can be assured even for high latency transmissions, especially in an satellite environment.

As can be seen from the timing diagrams of FIG. 3, the UE 110 transmits a preamble at T1 and in the absence of RAR message being received, the UE 110 reinitiates the preamble transmission at T2. After T2+3 ms the UE 110 receives a RAR message. From the base station's point of view, the base station 120 receives the preamble transmission later due to the large propagation delay in the satellite network (i.e., at T1+6). The base station transmits the RAR message, e.g., at T1+6+2 ms and the UE 110 receives it at T1+6+6+2 ms, which also corresponds to the T2+3. Because the base station 120 does not know which PRACH preamble the UE 110 will use in its PRACH retransmission (but the base station 120 does know when the UE 110 will retransmit), the RAR message contains an uplink grant allocation for each of the 4 possible preambles (numberOfRA-Preambles) that the UE 110 could have retransmitted. The base station 110 can also use the timing of the second message 1 from the UE 110 to determine the actual propagation delay (even though this is too late to include in its RAR message). However, the base station 120 can use this for a subsequent correction of PUSCH resource allocation for the UE 110.

When only a single UE is attempting to set up a communication channel with the base station 120 (accessing on PRACH) at times T1 and T2, then this process can work without ambiguity even though the randomised system that is intended to reduce contention is being circumvented by reducing the number of possible preamble signatures and transmitting all possible preambles at once in (all) message 2s.

For each preamble a, b, c and d, the RAR message (message 2) allocates PUSCH resources. These resources (timings and/or frequency allocation) are used by the UE to send the UE's message 3 (a RRCConnectionRequest, which contains the UE's 40 bit temporary ID, or a randomly allocated 40 bit number). This method can reduce the need for contention resolution and maintain or increase the random-access-procedure capacity of the system.

The PRACH configuration index 19 in Table 5.7.1-2 of TS 36.211 may be assumed, which means a preamble in in format 1 with subframe number 1 and PRACH is located in any radio frame. In RACH-ConfigCommon in SIB 2, the number of RA preambles (numberOfRA-Preambles) is restricted to a minimum of four [TS 36.331].

Further enhancements to the method can be achieved by adjusting the process with changes in demand or communications traffic. The system 100 may contain a plurality of base stations 120 and many UEs. Assuming only a single UE 110 is accessing at time T1 and T2, then, to minimize unused PUSCH resources, the base station 120 can allocate the same PUSCH resources for all of preambles a, b, c, and d. In other words, its RAR message (message 2) can contain the same PUSCH resources for each preamble signature. This can be described as the first approach and can be extended for a low number UEs.

However, if there are two (or multiple) UEs accessing on PRACH at T1 and/or T2 then two (or more) UEs may send their “message 3” at the same time and on the same radio resource (because they consider that these identical resources have been allocated to them) leading to a collision. With ‘power ramping’ of PRACH retransmissions, and different propagation losses across the cell (or a satellite beam) then there may be a reasonable chance that due to “FM capture” one (or with techniques such as Successive Interference Cancellation) more than one of the “message 3s” can be decoded and message 4 (containing the UE's temporary ID/random number) can be sent to one of the UEs—and successfully received by that one UE only. The unsuccessful UE will have to restart the random access process with a further message 1.

A second (alternative) approach is that the base station 120 allocates non-overlapping or different PUSCH resources for each of preamble signature (e.g., a, b, c, and d). While this consumes more uplink radio resources, if more than one UE 110 is accessing at time T1 and T2, it gives a higher probability that the message 3 transmissions do not interfere with each other. This reduces the resulting PRACH retransmissions caused by message 3 collision (restarting the process with a message 1) and therefore reduces the risk of ‘random access channel congestion’ that can (catastrophically degrade PRACH throughput).

A third approach is that the base station 120 ignores any transmitted PRACH (message 1), and once per RAR window sends a RAR message (message 2) that allocates PUSCH resources for all available preamble signatures (e.g., a, b, c, and d). Preferably in this scenario, the PUSCH resources will be non-overlapping, especially if high communications traffic is predicted or detected. This approach improves control plane latency, and dramatically increases PRACH capacity compared to a traditional ‘slotted ALOHA’model.

The base station 120 can alter its behaviour based on communications traffic (either predicted or detected). There are different ways in which the base station 120 can determine communications traffic level and change its behaviour based on whether a communications traffic threshold has been reached or exceeded.

For example, the PRACH load over the recent time (e.g., last 100 ms /10 maximum size RAR windows) can indicate a communications traffic level as can the number of non-decodable message 3 transmissions. Again, if this reaches or breaches a threshold then this can indicate a high PRACH load.

For low communications traffic and/or low PRACH load then the first approach provides overall advantages. For higher loads or where communications traffic reaches or exceeds a predetermined threshold then either or both of the second and third approaches can be used.

The base station 120 or other components in the network may also use historical records to determine an expected communications traffic level at particular times and therefore which approach to use. For example, it may be expected that internet of things (IoT) devices have somewhat synchronized accesses at the hour and half-hour time boundaries (over a 24 clock). Hence from a few seconds before an hour boundary until the load subsides, approaches two and/or three can be used. The base station 120 can then revert to the first approach at other times.

In another example, a second UE may be transmitting preamble p3 at T2 (this could be the first, second, third, etc. transmission of its message 1 by the second UE). Given that RAR message includes a response for p3 (because it includes all preamble signatures), then the second UE may accept the response (including allocated uplink grant and timing advance). However, these values correspond to the message 1 transmitted by the first UE 110 at T1. The uplink transmission of message 3 by the second UE will cause interference to the other UE 110. Moreover, the second UE may only realise its transmission has failed at the contention resolution timer expiry (i.e., it doesn't receive a message 3 from the base station 120 that include its temporary 40 bit id because the 40 bit id relates to the other UE). Therefore, this delays the second UE from reattempting to access the network. The temporary id may take other formats or lengths.

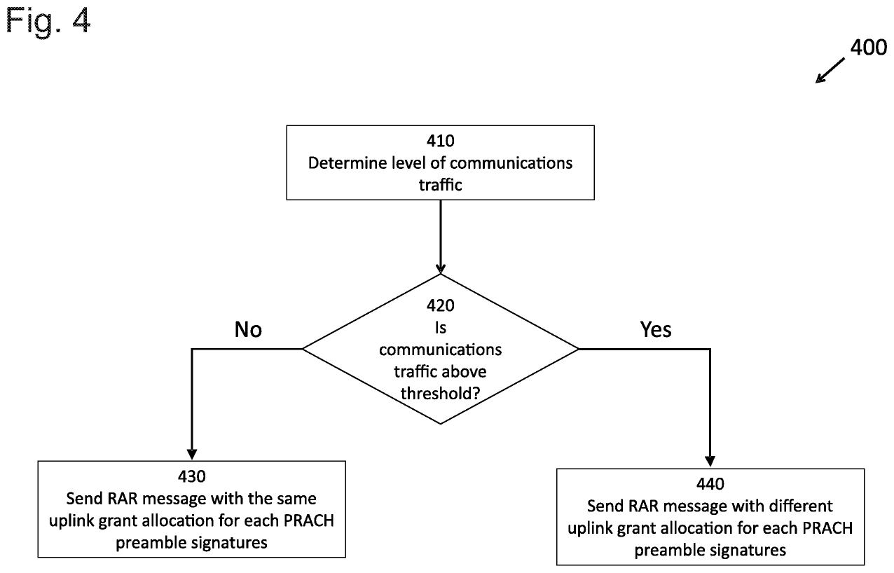

FIG. 4 shows a flowchart of a method 400 for providing a communications channel between the UE 110 and the base station 120. The method 400 can be extended to a plurality of UEs. At step 410 the base station determines a level of communications traffic. At step 420 a decision is made whether the communications traffic (e.g., PRACH load) is above a particular threshold. The threshold may be predetermined or dynamic, for example.

If the communications traffic is above the threshold, then the method 400 moves on to step 430 and a RAR message is transmitted from the base station 120 with the same uplink (UL) grant allocation provided to each PRACH preamble signature. If the communications traffic is below the threshold, then instead the method 400 continues to step 440 where a RAR message is also transmitted but it contains a different UL grant allocation for each PRACH preamble signature. The method 400 may be repeated at intervals or prompted by receiving a message 1 from one or more UEs.

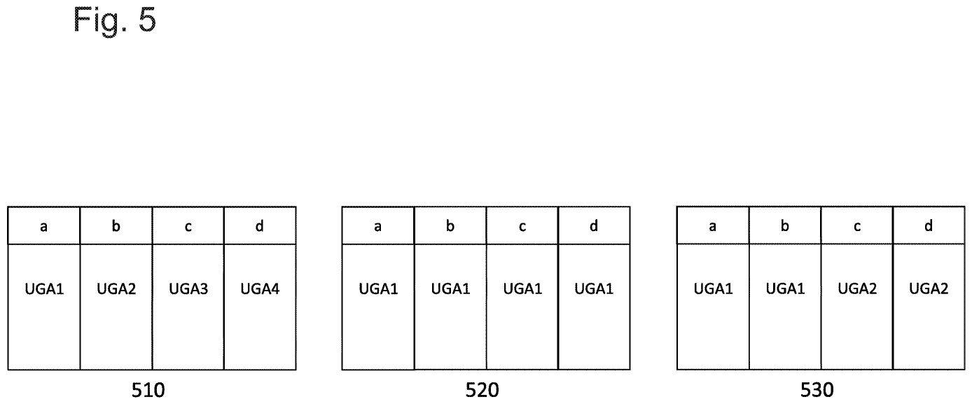

FIG. 5 shows a schematic diagram of different RAR messages 510, 520, 530. In this example, there are four possible PRACH preamble signatures (a, b, c, and d) although there may be a different number. The letters a, b, c, and d are only used as example signatures and any characters or data may be used.

As shown in FIG. 5, each RAR message 510, 520, 530 contains the PRACH preamble signature within a separate header. Each header is associated with an uplink grant allocation (UGA). Therefore, there can be four different UGA values (UGA1, UGA2,UGA3, or UGA4). In RAR message 510 all UGA information for each PRACH preamble signature is different (non-overlapping). In RAR message 520 all UGA for each PRACH preamble signature is the same (UGA1). In RAR message 530 some PRACH preamble signatures have the same UGA (a/b and c/d). Any other combinations are possible and these can be tuned based on communications traffic levels, for example.

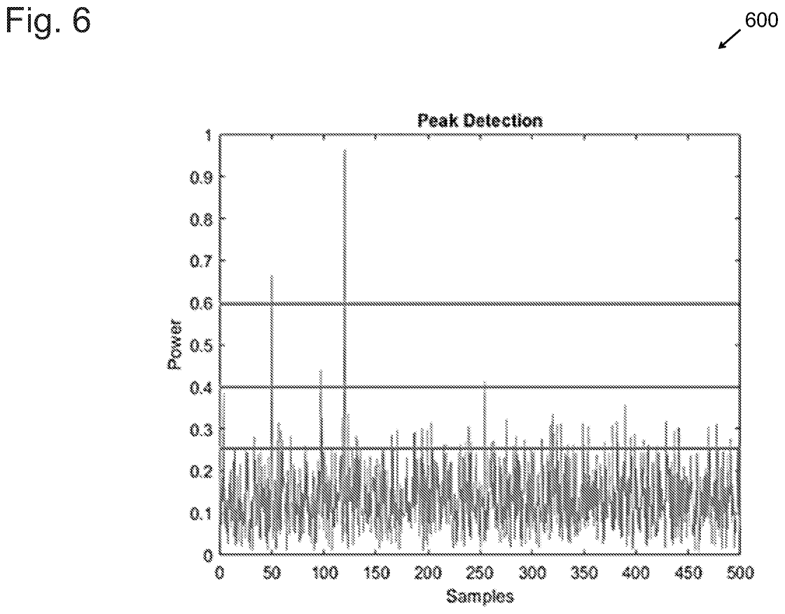

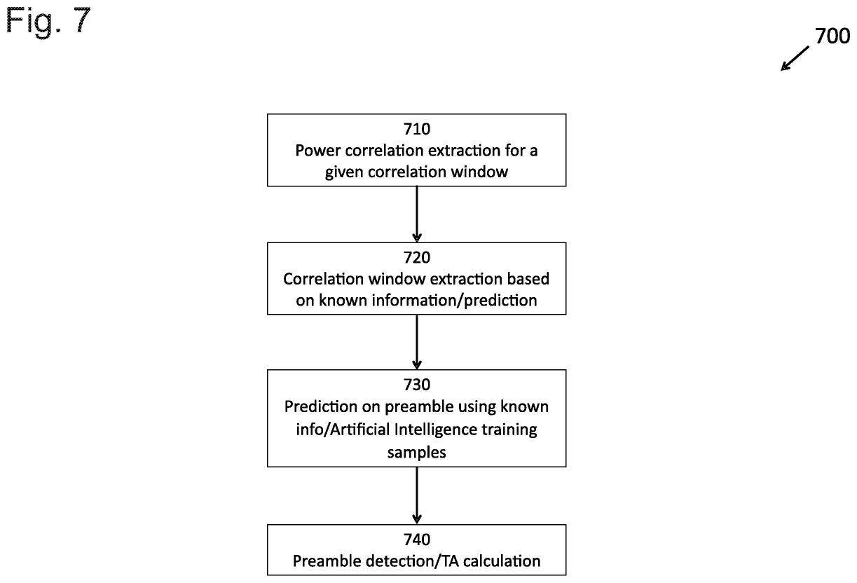

Preamble detection at the base station 120 is normally based on peak detection in the power domain. FIG. 6 shows an example graph 600 of such a power distribution. The known information (preamble transmission) at the base station 120 can be used to enhance preamble detection. FIG. 7 shows a flowchart of a method 700 for such enhanced preamble detection using the known information or prediction results at the base station 120.

At step 710, power correlation extraction is provided for a given correlation window. At step 720, correlation window extraction is based on known information or on prediction. At step 730, a prediction on preamble using known information or Artificial Intelligence (AI) training samples. At step 740, preamble detection and timing advance calculation is made.

This method 700 is not only used for the preamble detection, but also in the detection of scheduled transmissions (message 3 in FIG. 2) as this can be enhanced by using the known information or predictions at the base station 120.

As previously described, there might be ambiguity when a UE 110 receives the RAR message (message 2) from the base station and starts transmission using the allocated or scheduled uplink grant. The first UE 110 considers the random access response message is for its own transmission while the second UE also considers that the random access response provides the same uplink grant and timing advance (TA) for its own transmission. Therefore, the second UE will receive an incorrect TA value. As the first and second UEs may be located different distances from the base station 120, then they may experience different transmission delays. The base station 120 may receive the message 3 from the first and second UEs at different time locations. By the time the scheduled uplink (UL) transmission is received at the base station 120, the base station 120 has also received the preamble (a message 1) transmitted by the second UE at T2.

Therefore, the base station 120 can use this information to predict the behaviour of the second UE. Using this UE behaviour prediction, the base station 120 can decode the scheduled UL transmission from the second UE as well. And hence early contention resolutions are possible. This information can be used when the base station 120 moves on to responding to the second UE and so the UL TA information in the message 2 can be more accurate and not require adjustment or correction.

In another example, the base station 120 can use the prediction based on physical events or incidents that have occurred in an area covered by the base station 120 (or a satellite reception patch) to enhance the detection of the preamble and the scheduled transmissions.

As used throughout, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A”is true, “B is true”, or both “A”and “B”are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described throughout, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

Unless otherwise described, all technical and scientific terms used throughout have a meaning as is commonly understood by one of ordinary skill in the art to which the various embodiments described herein belongs.

As will be appreciated by the skilled person, details of the above embodiment may be varied without departing from the scope of the present invention, as defined by the appended claims.

For example, whilst only two UEs are mentioned, any number may be present in the system. The timing advance that the base station includes in its RAR messages may be zero for every preamble. Therefore, every timing advance can be corrected when the actual parameters can be calculated by the base station. When unprompted message 2s are transmitted then then can be done at different intervals, which may be adjusted based on traffic or other conditions.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

The following numbered clauses indicate example implementations:
1 A method for providing a communications channel between a user equipment (UE) and a base station, the method comprising the steps of:
   the base station determining a level of communications traffic; and
   the base station transmitting a random access response (RAR) message including a plurality of different physical random access channel (PRACH) preamble signatures, wherein
   if the determined level of communications traffic is below a threshold then the RAR message includes the same uplink grant allocation for each of the plurality of different PRACH preamble signatures; and
   if the determined level of communications traffic is above the threshold then the RAR message includes different uplink grant allocations for each of the plurality of different PRACH preamble signatures.
2. The method of clause 1, wherein the plurality of different PRACH preamble signatures are all possible PRACH preamble signatures for the base station.
3. the method of clause 1 or clause 2, wherein there are four different PRACH preamble signatures.
4. The method according to any previous clause, wherein:
   the base station transmits the RAR message in response to receiving a message from the UE containing a single PRACH preamble signature of the plurality of PRACH preamble signatures; or
   the base station transmits the RAR message in the absence of receiving a message from a UE containing a single PRACH preamble signature of the plurality of PRACH preamble signatures.
5. The method of clause 4 further comprising the steps of:
   the base station allocating packet uplink shared channel, PUSCH, resources to the UE that transmitted the message containing the single PRACH preamble signature; and
   the base station transmitting a further message to the UE containing an identifier of the UE, wherein the further message confirms the PUSCH resources allocated to the UE.
6. The method of clause 4 or clause 5, wherein the message received by the base station is a second message transmitted by the UE containing a PRACH preamble signature, wherein a first message transmitted by the UE contains a different PRACH preamble signature of the plurality of PRACH preamble signatures to the second message transmitted by the UE.
7. The method according to any previous clause, wherein the base station determines a level of communications traffic based on:
   a number of messages received by the base station containing a single PRACH preamble signature within a time period, and/or a number of non-decodable messages received from one or more UE containing a single PRACH preamble signature.
8. The method according to any previous clause, wherein the base station determines a level of communications traffic based on historical records of communications traffic.
9. The method of clause 8, wherein the historical records of communications traffic are analysed using artificial intelligence, AI.
10. The method according to any previous clause, wherein the RAR message further includes the same timing advance information for each of the plurality of different PRACH preamble signatures.
11. The method according to any previous clause, wherein the RAR message including the plurality of different PRACH preamble signatures is repeated at regular time intervals.
12. The method of clause 11, wherein the RAR message is repeated once every RAR window.
13. The method according to any previous clause further comprising the steps of:
   the base station receiving a message from the UE containing a single PRACH preamble signature of the plurality of PRACH preamble signatures;
   determining that the message received from the UE does not comply with timing advance information allocated to the PRACH preamble signature within the message; and
   transmitting a further RAR message containing a further uplink grant allocation, wherein the further uplink grant allocation has a timing advance based on a position of a RAR window when the messages was received from the UE.
14. The method according to any previous clause, wherein if the base station receives two or more messages from different UEs, wherein the two or more messages contain the same PRACH preamble signature then:
   the base station allocating one set of packet uplink shared channel, PUSCH, resources;
   The different UEs using these PUSCH resources to send a message containing their identifiers; and
   the base station selecting one of the UE identifiers and responding with a message containing the selected UE identifier.
15. A satellite telecommunication system comprising:
   one or more base stations having means adapted to execute the steps according to any previous clause.

1. A method for providing a communications channel between a user equipment (UE) and a base station, the method comprising of:
the base station determining a level of communications traffic; and
the base station transmitting a random access response (RAR) message including a plurality of different physical random access channel (PRACH) preamble signatures,
wherein if the determined level of communications traffic is below a threshold then the RAR message includes a same uplink grant allocation for each of the plurality of different PRACH preamble signatures,
wherein if the determined level of communications traffic is above the threshold then the RAR message includes different uplink grant allocations for each of the plurality of different PRACH preamble signatures,
wherein the plurality of different PRACH preamble signatures are all possible PRACH preamble signatures for the base station, and
wherein the base station transmits the RAR message in absence of receiving a message from a UE including a single PRACH preamble signature of the plurality of PRACH preamble signatures.

2. The method of claim 1, wherein there are four different PRACH preamble signatures.

3. The method according to claim 1, wherein the base station is configured to transmit the RAR message in response to receiving a message from the UE including a single PRACH preamble signature of the plurality of PRACH preamble signatures.

4. The method of claim 3 further comprising:
the base station allocating packet uplink shared channel, PUSCH, resources to the UE that transmitted the message including the single PRACH preamble signature; and
the base station transmitting a further message to the UE including an identifier of the UE, wherein the further message confirms the PUSCH resources allocated to the UE.

5. The method of claim 3, wherein the message received by the base station is a second message transmitted by the UE including a PRACH preamble signature, and
wherein a first message transmitted by the UE includes a different PRACH preamble signature of the plurality of PRACH preamble signatures to the second message transmitted by the UE.

6. The method according to claim 1, wherein the base station determines a level of communications traffic based on:
a number of messages received by the base station including a single PRACH preamble signature within a time period, and/or
a number of non-decodable messages received from one or more UE including a single PRACH preamble signature.

7. The method according to claim 1, wherein the base station determines a level of communications traffic based on historical records of communications traffic.

8. The method of claim 7, wherein the historical records of communications traffic are analyzed using artificial intelligence, AI.

9. The method according to claim 1, wherein the RAR message further includes a same timing advance information for each of the plurality of different PRACH preamble signatures.

10. The method according to claim 1, wherein the RAR message including the plurality of different PRACH preamble signatures is repeated at regular time intervals.

11. The method of claim 10, wherein the RAR message is repeated once every RAR window.

12. The method according to claim 1, further comprising:
the base station receiving a message from the UE including a single PRACH preamble signature of the plurality of PRACH preamble signatures;
determining that the message received from the UE does not comply with timing advance information allocated to the PRACH preamble signature within the message; and
transmitting a further RAR message including a further uplink grant allocation, wherein the further uplink grant allocation has a timing advance based on a position of a RAR window when the messages was received from the UE.

13. The method according to claim 1, wherein if the base station receives two or more messages from different UEs, and the two or more messages include a same PRACH preamble signature then perform operations comprising:
the base station allocating one set of packet uplink shared channel, PUSCH, resources;
the different UEs using the PUSCH resources to send a message including respective UE identifiers; and
the base station selecting one of the UE identifiers and responding with a message including the selected UE identifier.

14. A satellite telecommunication system comprising:
one or more base stations configured to perform the operations of claim 1.
